(19) United States
(12) Patent Application Publication
(10) Pub. No.: US 2021/0033630 A1
(43) Pub. Date: Feb. 4, 2021

(54) METHOD FOR TESTING, VERIFYING, CALIBRATING OR ADJUSTING AN AUTOMATIC ANALYSIS APPARATUS

(71) Applicant: Endress+Hauser Conducta GmbH+Co. KG, Gerlingen (DE)

(72) Inventors: Matthias Knopp, Weissach-Flacht (DE); Anja Gerlinger, Stuttgart (DE)

(21) Appl. No.: 16/942,966

(22) Filed: Jul. 30, 2020

(30) Foreign Application Priority Data
Jul. 30, 2019 (DE) 10 2019 120 494.1

(51) Int. Cl. G01N 35/00; G01N 35/10; G01N 27/06

(52) U.S. Cl. CPC G01N 35/00584; G01N 27/06; G01N 35/1097

(57) ABSTRACT

A method is disclosed for determining a parameter dependent on the concentration of a substance in a sample liquid. The method includes determining a first measured value representing a value of the parameter in a first standard solution using the automatic analysis apparatus, wherein the value of the parameter in the first standard solution is known, and determining a second measured value representing a value of the parameter in a second standard solution using the automatic analysis apparatus, wherein the value of the parameter in the second standard solution is known and differs from the value of the parameter in the first standard solution. The first standard solution or the second standard solution is automatically produced using the analysis apparatus by mixing a predetermined volume of a stock solution containing the substance and a predetermined volume of a dilution liquid.

### CROSS-REFERENCE TO RELATED APPLICATION

The present application is related to and claims the priority benefit of German Patent Application No. 10 2019 120 494.1, filed on Jul. 30, 2019, the entire contents of which are incorporated herein by reference.

### TECHNICAL FIELD

The present disclosure relates to a method for testing, verifying, calibrating or adjusting an automatic analysis apparatus for determining a parameter dependent on the concentration of at least one substance in a sample liquid.

In process measuring technology, e.g., in chemical, biotechnological, or food technology processes, as well as in environmental metrology, such automatic analysis apparatuses are used for determining a measurand of a liquid sample. Analysis apparatuses may, for example, be used to monitor and control processes in sewage and water treatment plants, to monitor drinking water, or to monitor the quality of foods. Measured and monitored is, for example, the proportion of a certain substance, which is also called an analyte, in a sample liquid such as a liquid or a liquid mixture, e.g. a homogeneous solution, an emulsion, or a suspension.

Parameters measured by analysis apparatuses can be, for example, concentrations of individual analytes. These are, inter alia, ion concentrations, for example the concentration of ammonium, nitrate, phosphate, silicate. Other parameters which are determined by analysis apparatuses in process measurement technology, especially in the monitoring of water or water treatment and water purification processes, are sum parameters such as total organic carbon (also: TOC), total nitrogen (also: TN), total phosphorus (also: TP) or chemical oxygen demand (also: COD). The value of such sum parameters is influenced by the concentration of a plurality of substances/analytes in the sample liquid. Analysis apparatuses may, for example, be designed as cabinet devices or buoys.

In analysis apparatuses, one or more reagents are frequently added to a sample to be analyzed in order to measure the parameter, so that a chemical reaction occurs in the reaction mixture formed from the sample and the reagents. The reagents are frequently corresponding reactants for disintegration of the sample and/or detection of solutions comprising the analyte, of which a measured volume is added to the sample. The composition of the reagents is preferably selected such that the chemical reaction is detectable by physical methods, e.g., by optical measurements, using electrochemical sensors, or by a conductivity measurement. By means of a measuring sensor, measured values of a measurand that is correlated with the analytical parameter (such as a concentration or a sum parameter) actually to be determined are detected accordingly. The chemical reaction may, for example, cause a coloring or a change in color which may be detected using optical means. In such cases, the intensity of the color is a measure of the parameter to be determined. The measurand correlated with the parameter to be determined can be, for example, photometric detection of an absorption or extinction by the treated sample by radiating electromagnetic radiation, e.g. visible light, from a radiation source into the reaction mixture of liquid sample and reagents and receiving it with a suitable receiver after transmission through the reaction mixture. The receiver generates a measurement signal which is dependent upon the intensity of the radiation received and from which the measured value of the parameter to be determined may be determined, e.g. on the basis of a calibration function or a calibration table.

The prior art discloses automatic analysis apparatuses which are configured to pre-treat liquid samples by means of thermal disintegration and/or by addition of reagents for a subsequent optical, e.g. photometric or spectrophotometric, electrochemical or other determination of a measured value representing the parameter of the liquid sample to be determined, for example in DE 10 2011 075762 A1, DE 10 2015 117637 A1 or DE 10 2015 119608 A1.

The apparatuses known from the prior art can contain one or more storage containers with one or more standard solutions for calibrations. For example, DE 10 2015 119608 A1 describes a calibration cycle in which a standard solution having a known value of the parameter to be determined by the analysis apparatus is conveyed from such a storage container into a measuring cell of the apparatus, and how a “real” liquid sample is mixed with one or more reagents. By means of the measuring sensor of the analysis apparatus, a measured value of the parameter is determined photometrically just as in a measurement of an unknown liquid sample and an adjustment of the analysis apparatus is performed if necessary based on the value of the parameter known for the standard.

DE 10 2016 105 770 A1 discloses an automatic analysis apparatus which has a dilution module for dilution of the sample liquid before analysis and can in this way cover a large range of concentrations of an analyte. The apparatus has one or more storage containers with standard solutions for carrying out calibrations or adjustments.

The calibration of such analysis apparatuses with a single standard solution held in a storage container in the analysis apparatus results in a single measured value which can be used to carry out a test of the analysis apparatus. This single value can also be used to adjust the apparatus. However, it would be desirable to enable more accurate testing of the apparatuses, advantageously over their entire measurement range, or to provide a correspondingly improved adjustment. However, determining a plurality of measured values using a plurality of corresponding standard solutions which have different values of the parameter to be determined within the measurement range is complex because these solutions must be provided simultaneously or successively depending on the analysis apparatus. This can be achieved by providing a series of storage containers with standard solutions of different composition, each of which can be connected to the measuring cell via an identical number of connections. In conventional analysis apparatuses, however, there is insufficient space for a corresponding number of storage containers. Alternatively, a user can connect the various standard solutions to one or a few connections successively to provide them to the analysis apparatus. This takes time and increases labor requirements.

### SUMMARY

It is therefore the object of the present disclosure to provide a method which allows more precise testing of a generic automatic analysis apparatus and which does not have the abovementioned disadvantages.

This object is achieved by the method and the automatic analysis apparatus.

Exemplary embodiments are disclosed herein.

The method according to the present disclosure for testing, verifying, calibrating or adjusting an automatic analysis apparatus for determining a parameter dependent on the concentration of at least one substance in a sample liquid comprises steps of determining a first measured value representing a value of the parameter in a first standard solution by means of the automatic analysis apparatus, wherein the value of the parameter in the first standard solution is known, and determining at least one second measured value representing a value of the parameter in at least one second standard solution by means of the automatic analysis apparatus, wherein the value of the parameter in the at least one second standard solution is known and differs from the value of the parameter in the first standard solutions. The first standard solution or the at least one second standard solution is automatically produced using the analysis apparatus by mixing in each case a predetermined volume of at least one stock solution containing the at least one substance and a predetermined volume of a dilution liquid.

Because the analysis apparatus itself, i.e. automatically, generates the required standard solutions for testing, verifying, calibrating or adjusting based on at least two measurements in at least two standard solutions having different values of the parameter by diluting a stock solution, a plurality of standard solutions can be made available to the analysis apparatus without additional space for storage containers or additional labor being required.

The measured values can be determined, for example, depending on the type of parameter to be determined, by the detection of a measurement signal by means of a measuring sensor directly in the standard solution, by the detection of a measurement signal by means of a measuring sensor in a sample of the standard solution treated by chemical reaction with one or more detection and/or disintegration reagents, or by the detection of a measurement signal by means of a measuring sensor in a thermally disintegrated sample of the standard solution which is at least partially converted into the gas phase.

The term calibrating is understood here and hereinafter to mean the determination of a deviation of a determined measured value of the parameter in a standard solution from the known measured value of this standard solution, which is assumed to be correct. Verifying also includes the determination of the deviation and the assessment or evaluation thereof. Adjusting is understood to mean the adaptation of the analysis apparatus in such a way that a model, e.g. a calibration function or calibration table based on which the analysis apparatus determines a measured value of the parameter from a measurement signal supplied by a measuring sensor, is adapted such that it agrees with the known value of the parameter in the standard solution serving as a reference value.

In an advantageous embodiment, more than two measured values can be determined by means of correspondingly more than two standard solutions, wherein the known value of the parameter in each standard solution differs from the corresponding values of the other standard solutions. In this case, several or all standard solutions are advantageously generated automatically by means of the analysis apparatus by mixing a predetermined volume of at least the stock solution and a predetermined volume of the dilution liquid. A measured value is determined for each of these standard solutions.

One of the measured values can be determined for the undiluted stock solution or for the pure dilution liquid.

The use of precisely one stock solution is especially advantageous because it is especially space-saving. The value of the parameter in the stock solution may lie in an upper part of the measurement range of the analysis apparatus, e.g. it may be at least 80% or more of the upper limit of the measurement range. The parameter value in the stock solution can also lie above the upper limit of the measurement range, then the stock solution is diluted with the dilution liquid for each of the measured values to be determined in such a way that the known values of the standard solutions lie within the measurement range of the analysis apparatus.

The known values of the parameter in the standard solutions are advantageously selected such that they are distributed over the entire measurement range of the analysis apparatus. The value of the parameter in the first standard solution may lie, for example, in a value interval of 0 to 50% of an upper limit of a measurement range of the analysis apparatus, the value of the parameter in the at least one second standard solution may lie in a value interval of 50 to 100% of the upper limit of the measurement range of the analysis apparatus. If three measured values are determined in three different standard solutions, the value of the parameter in the first standard solution can lie in a value interval of 0 to 20% of the upper limit of the measurement range of the analysis apparatus, the value of the parameter in the second standard solution can lie in a value interval of 20 to 80% of the upper limit of the measurement range of the analysis apparatus, and the value of the parameter in the third standard solution can lie in a value interval of 80 to 100% of the upper limit of the measurement range of the analysis apparatus. The order in which the measured values of the individual standard solutions are determined plays no part. This can be selecting according to increasing or decreasing parameter value or completely freely.

The parameter can be, for example, an ion concentration, e.g. of ammonium, phosphate, nitrate or silicate. In this case, the substance contained in the stock solution is the corresponding ion. It is also possible for the parameter to be a sum parameter dependent on the concentration of a plurality of substances, e.g. the total chemical oxygen demand, the total organic carbon content or the total nitrogen content. In this case, the stock solution may contain a predetermined concentration of one or more substances included in the sum parameter.

The automatic analysis apparatus can be tested, verified, calibrated or adjusted based on the determined measured values. It is advantageous for the analysis apparatus to carry out a self-test, self-verification, self-calibration, or self-adjustment automatically. For this purpose, the analysis apparatus can comprise analysis apparatus electronics in which algorithms used for determining the measured values and for testing, verifying, calibrating or adjusting are stored in the form of computer programs, wherein the analysis apparatus electronics are configured to execute the algorithms. For example, said electronics may comprise a data processing device with memory and processors.

The analysis apparatus may additionally have a mixing device, wherein the analysis apparatus electronics control the mixing device to produce the first and/or the at least one second standard solution. If a third and possibly further standard solutions are produced, the analysis apparatus electronics can accordingly also control the mixing device to produce these standard solutions.

The mixing device can have a valve device and at least one pump, wherein the valve device is configured to create a fluid connection between the at least one pump and, optionally, a storage container containing the stock solution and/or a dilution liquid source. To produce the standard solutions, the analysis apparatus electronics can control the at least one pump and the valve device in order to convey a predetermined volume of the stock solution and a predetermined volume of the dilution liquid and to mix the predetermined volumes of the stock solution and the dilution liquid with one another.

The volumes of the stock solution and the dilution liquid required to produce one of the standard solutions can be predetermined by a control algorithm executed by the analysis apparatus electronics in such a way that the first and the at least one second standard solution have the predetermined known first and second value of the parameter.

From the first and the at least one second measured value and the known values of the parameter in the first standard solution and the at least one second standard solution, the analysis apparatus electronics can be used to determine a predetermined model function, for example a best-fit line, which reflects the development of the first and of the at least one second measured value as a function of the known values of the parameter. In an advantageous embodiment, this is done by means of the analysis apparatus electronics. If, in one of the method variants described above, a plurality of, e.g. three or more, measured values of the parameter are determined in three or more different standard solutions, the best-fit function, which may be, for example, a best-fit line, reflects the development of the plurality of measured values as a function of the known values of the parameter.

The model function can, if necessary together with the determined measured values, be shown on a display of the analysis apparatus. This enables testing of the functioning of the analysis apparatus as well as verification or calibration by a user.

The method may further comprise determining a correlation coefficient of the model function, e.g. the best-fit lines. The correlation coefficient can be compared to a predetermined target value of the correlation coefficient. This enables self-calibration, self-verification, self-testing and self-adjustment of the analysis apparatus by the analysis apparatus electronics. The correlation coefficient may also be output to a user via a display to enable manual verification, calibration, or adjustment.

The method may further comprise adjusting the analysis apparatus by storing a calibration function derived from the determined model function for the determination of measured values of the parameter using the automatic analysis apparatus.

The present disclosure also comprises an automatic analysis apparatus for determining a parameter of a sample liquid that is dependent on the concentration of at least one substance. This analysis apparatus includes at least one storage container having a stock solution containing the at least one substance, and a mixing device configured to mix a predeterminable volume of the stock solution with a predeterminable volume of the dilution liquid so as to obtain a standard solution having a known value of the parameter in the standard solution. The automatic analysis apparatus also includes an analysis apparatus electronics, and a measuring sensor which is connected to the analysis apparatus electronics to transmit measurement signals from the measuring sensor to the analysis apparatus electronics and which is designed to generate a measurement signal representing a value of the parameter in the standard solution. The analysis apparatus electronics are configured to control the mixing device and to process the measurement signal from the measuring sensor in order to determine a measured value representing the value of the parameter in the standard solution, and wherein the analysis apparatus electronics are further configured to execute the method for testing, verifying, calibrating or adjusting according to one of the embodiments described above.

It is advantageous for the value of the parameter in the stock solution to be known and to be greater than or equal to 80% of the upper limit of a measurement range of the analysis apparatus.

The mixing device of the analysis apparatus can have liquid lines and, if needed, liquid containers, as well as pumps and valves which are designed for transporting and for metering the predeterminable volumes of the liquids to be mixed.

### BRIEF DESCRIPTION OF THE DRAWINGS

In the following, the present disclosure is explained in further detail on the basis of the exemplary embodiments shown in the figures. They show:

FIG. 1 shows a schematic illustration of an automatic analysis apparatus for determining an ion concentration in a liquid sample; and

FIG. 2 shows an illustration of a best-fit line determined using a plurality of measured values in standard solutions having different ion concentrations.

### DETAILED DESCRIPTION

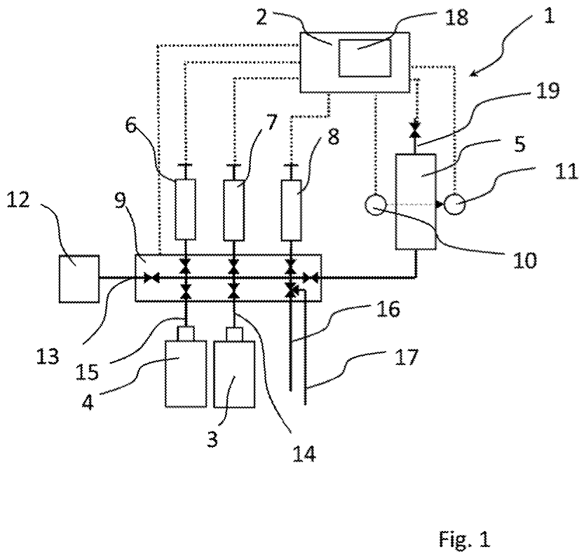

FIG. 1 schematically shows an automatic analysis apparatus 1 for determining a parameter of a liquid sample. In the present example, the parameter is a concentration of an analyte in a liquid sample. The liquid sample may be a specified volume of sample liquid which may be, for example, water, such as drinking water or wastewater. The analyte can be, e.g. a specific ion present in the sample liquid, such as ammonium or phosphate.

The analysis apparatus 1 has analysis apparatus electronics 2 which are configured to control components of the analysis apparatus 1 entirely automatically in order to meter a liquid sample for carrying out a photometric measurement and to treat it with reagents, as well as to carry out photometric measurements and to determine a value of the ion concentration from the determined measured values. The analysis apparatus 1 comprises a plurality of storage containers 3, 4 for liquids, a measuring cell 5, a plurality of pumps 6, 7, 8, liquid lines and a plurality of valves, some of which are combined in a central valve switching mechanism 9 or valve block. In order to determine measured values, the analysis apparatus 1 has a photometric measuring sensor with a radiation source 10 and a radiation detector 11. The radiation source 10 is connected to the analysis apparatus electronics 2, which are configured to control the radiation source in order to emit radiation. The radiation detector 11 is connected to the analysis apparatus electronics 2 in order to transmit measurement signals from the radiation detector 11 to the analysis apparatus electronics 2. The latter are configured to receive and process the measurement signals in order to determine measured values of the parameter therefrom.

The measuring cell 5 has a housing that is transparent to radiation from the radiation source 10. For example, for measurement radiation in the UV/vis range, it can be made completely of glass or quartz glass. A closable ventilation or pressure equalization line 19 opens into the measuring cell 5. This equalizes pressure when liquid is introduced into the measuring cell 5 or when liquid is discharged from the measuring cell 5.

The radiation source 10 and the radiation detector 11 are arranged opposite to each other in such a way with respect to the measuring cell 5 that radiation emitted by the radiation source passes through the measuring cell 5 and a liquid contained therein before striking the radiation detector 11.

A first liquid line 13 connects a sample holder 12 for sample liquid to a first pump 6 and the measuring cell 5 via the central valve switching mechanism 9. In the present exemplary embodiment, all pumps 6, 7, 8 are designed as syringe pumps or piston pumps. In an alternative embodiment, however, the pumps can also be designed as peristaltic pumps/hose pumps or as diaphragm pumps. In this case, the placement of the liquid lines and the positions of the valves are adapted accordingly.

The storage container 3 for liquids contains a reagent which is to be added to the sample liquid in order to form a reaction mixture on which a photometric measurement is then carried out in the measuring cell 5. A second liquid line 14 connects the storage container 3 to a second pump 7 and the measuring cell 5 via the valve switching mechanism 9. Depending on which parameter the analysis apparatus 1 is determining, there can also be a plurality of storage containers as different reagent containers to be added to the liquid sample. These can accordingly be connected to a common or a plurality of individual pumps and the measuring cell 5 via further liquid lines and the valve switching mechanism 9.

A further storage container 4 for liquids contains a stock solution containing the analyte, e.g. phosphate or ammonium. Typically, the concentration of the analyte in the stock solution is known and stored in the analysis apparatus electronics 2. The concentration of the analyte in the stock solution corresponds to at least 80% of the upper limit of the measurement range of the analysis apparatus 1. A third liquid line 15 connects the storage container 4 to the first pump 6 and the measuring cell 5 via the valve switching mechanism 9.

A fourth liquid line 16 connects a dilution liquid source, e.g. a storage container with dilution liquid or a connection to a liquid line via which dilution liquid is provided, to a third pump 8 and the measuring cell 5 via the valve switching mechanism 9. Depending on which parameter is being determined by means of the analysis apparatus 1, water or another solvent can be used as the dilution liquid. If the dilution liquid is water, a water line can serve as the dilution liquid source.

The first pump 6, the third pump 8, the valve switching mechanism 9 and the liquid lines connecting the pumps 6 and 8 to the storage container 4 for the stock solution, to the dilution liquid source and to one another form a mixing device of the analysis apparatus 1 which is configured to produce standard solutions with a known value in each case of the parameter to be determined from a predeterminable volume of the stock solution and the dilution liquid. This function will be explained below.

A fifth liquid line 17 connects a collection container for consumable liquids (not shown in FIG. 1) to the third pump 8 and the measuring cell 5 via the valve switching mechanism 9.

The analysis apparatus electronics have display and input means; in the present example, these consist of a touchscreen display 18. They are connected to the valves and the valve switching mechanism 9, the pumps 6, 7, 8 and the photometric measuring sensor in order to control them and to detect and process measurement signals from the measuring sensor. For this purpose, the analysis apparatus electronics 2 have one or more memories in which algorithms for control and for measurement signal evaluation can be stored in the form of computer programs, and a computer which is configured to execute the computer programs and to output corresponding control signals to the components of the analysis apparatus and/or to carry out calculations for evaluating the measurement signals.

A method for determining measured values of the ion concentration will be described in more detail below. Even if not always specifically mentioned, in the present example all method steps are carried out completely automatically by the analysis apparatus electronics 2.

In a first step, the analysis apparatus electronics 2 control the first pump 6 and the valve switching mechanism 9 in order to convey a specified quantity, e.g. a specified volume, of a sample liquid from the sample holder 12. The volume of the sample liquid is metered using the stroke of the syringe plunger of the first pump 6, which is designed as a syringe pump. Next, the conveyed sample liquid is transported as a sample by means of the first pump 6 into the measuring cell 5 via the valve switching mechanism 9. Here, as well as in the further steps described below, the analysis apparatus electronics 2 control the pumps and valves of the valve switching mechanism 9 involved in each case in such a way that the liquids in each case are transported to their destination, while other possible pathways for the liquids are blocked by valves.

In a next step, the analysis apparatus electronics 2 control the second pump 7 and the valve switching mechanism 9 to convey a specified quantity, e.g. a specified volume, of the reagent contained in the liquid container 3. The volume of the reagent is metered based on the stroke of the syringe plunger of the second pump 7, which is designed as a syringe pump. The metered volume of the reagent is then metered into the measuring cell 5 by means of the second pump 7 via the valve switching mechanism 9 so that a reaction mixture of the sample and the added reagent is formed in the measuring cell 5. Depending on the type of analyte, a plurality of reagents can be metered in the same way and added to the sample to form a reaction mixture.

A chemical reaction takes place in the reaction mixture with the involvement of the analyte contained in the liquid sample, in which reaction a reaction product that is detectable by means of the photometric measuring sensor is formed. This reaction product can have, for example, a characteristic absorption at a wavelength of the measurement radiation emitted by the radiation source 10. The intensity of the measurement radiation detected by the radiation detector 11 is accordingly a measure of the concentration of the analyte in the reaction mixture, and thus also of the concentration of the analyte in the original sample liquid.

The analysis apparatus electronics 2 are configured to detect and process the measurement signals from the radiation detector 11 in order to determine measured values of the parameter. Measured values of the parameter to be determined by the analysis apparatus 1 can be determined from the measurement signals of the radiation receiver by, for example, assigning measured values in the physical units of the parameter to be determined to measurement signal values using a calibration function or a calibration table stored in a memory of the analysis apparatus electronics 2. The calibration function or calibration table can already have been determined and stored during the manufacture of the analysis apparatus 1. However, it is also possible for a user to determine and/or update the calibration function or calibration table based on a comparison with a standard. The latter is referred to as adjustment.

After detection of the measurement signals in the reaction mixture by means of the radiation detector 11, the reaction mixture is discharged from the measuring cell 5. Here, the third pump 8 sucks the reaction mixture out of the measuring cell 5 and transports the reaction mixture via the valve switching mechanism 9 into the collection container for used-up liquid via the fifth liquid line 17. One measurement cycle of the analysis apparatus 1 is thereby ended.

The analysis apparatus electronics 2 can optionally carry out one or more flushing steps between two measurement cycles, in which a cleaning liquid or the sample liquid is flushed by means of the first pump 6 through the valve switching mechanism 9 and the lines conducting the liquid sample or reagents and the measuring cell 5.

Testing, verification, calibration or adjustment of the analysis apparatus can be carried out between the measurement and flushing cycles, regularly or as necessary, e.g. in the event of a malfunction or suspected malfunction of the analysis apparatus, or as needed for other reasons. In an especially advantageous embodiment, this testing, verification, calibration or adjustment is done completely automatically by the analysis apparatus electronics 2. It can be started by an operator by a command entered via the touchscreen 18. However, it is also possible for the analysis apparatus electronics 2 to start the testing, verification, calibration or adjustment by itself regularly according to a predetermined schedule or based on a diagnostic program stored in the analysis apparatus electronics 2 upon detection of a malfunction or an imminent malfunction.

The testing, verification, adjustment or calibration comprises determining a plurality of measured values of the parameter to be determined by the analysis apparatus 1 using a series of standard solutions having a known value of the parameter. If, as here, the parameter is the concentration of a specific analyte, the standard solutions thus contain the analyte in a known concentration. The analysis apparatus electronics 2 can mix this series of standard solutions fully automatically in the analysis apparatus 1 using the stock solution and dilution liquid contained in the liquid container 4. This is described in more detail below.

In order to produce a standard solution with a first specific analyte concentration, the analysis apparatus electronics 2 control the first pump 6 and the valve switching mechanism 9 to remove a predetermined volume of the stock solution from the storage container 4. For this purpose, the first pump 6 sucks stock solution out of the storage container 4 via the valve switching mechanism 9, the volume removed from the storage container 4 being determined by the piston stroke of the first pump 6, which is designed as a syringe pump in the present example. By means of the third pump 8 and the valve switching mechanism 9, a specified volume of the dilution liquid is sucked in via the liquid line 16, the volume of the dilution liquid being determined by the piston stroke of the pump 8. The volumes of the stock solution and the dilution liquid to be metered are predetermined by the analysis apparatus electronics 2 such that a standard solution with a predetermined value of the parameter to be determined by the analysis apparatus 1, in the present example the analyte concentration, is generated by mixing the two metered volumes of the stock solution and the dilution liquid. After metering of the stock solution and the dilution liquid, the analysis apparatus electronics 2 control the valve switching mechanism 9 and the pumps 6 and 8 in such a way that the liquids are transported back and forth between the two pumps, so that mixing of the liquids is achieved. The mixture generated in this way is then introduced into the measuring cell 5 as a standard solution.

A measurement cycle is then carried out as described above for a liquid sample using the standard solution contained in the measuring cell 5 and measurement signals from the photometric measuring sensor are detected. The measurement signal or the measured value determined therefrom serves in the following as a measuring point for testing, verifying, calibrating or adjusting the analysis apparatus 1.

In the same way, further standard solutions of differing composition can be mixed to generate a plurality of such measuring points and measurement cycles can be correspondingly carried out using the standard solutions.

The analysis apparatus electronics 2 can generate predetermined volumes of the standard solutions, which are then transported in full into the measuring cell 5. Alternatively, they can also generate larger volumes, of which in each case only a part is transported into the measuring cell 5 in order to determine the measured value of the parameter. The remainder can be discarded by draining through the line 17. This can be useful to achieve a high dilution with sufficient precision.

A measuring point can also be determined for the pure dilution liquid (zero standard) as well as for the undiluted standard solution.

The number of measuring points and the predetermined values of the parameter to be determined in the standard solution can be predetermined by a user. They can be predetermined individually for a one-time execution of the testing method. Alternatively, however, it is also possible to store these values permanently, so that the analysis apparatus regularly carries out self-testing, self-verification, self-calibration or self-adjustment based on the stored values.

In further exemplary embodiments, it is possible that instead of a single stock solution, two or more stock solutions of identical or different concentrations can be provided in storage containers of the analysis apparatus in order to allow a longer service life and/or greater flexibility in setting specific concentrations in the standard solutions.

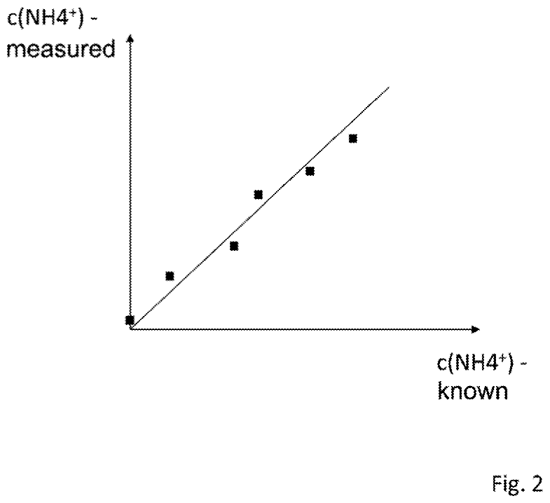

For testing, verifying or calibrating the analysis apparatus, the analysis apparatus electronics 2 can determine measured values of the analyte concentration from the measurement signals determined for the various standard solutions. They can use the stored calibration function or calibration table for this purpose. The analysis apparatus electronics 2 can determine a best-fit function which describes the development of the measurement signals of the radiation detector 11 or the measured values determined from the measurement signals as a function of the known concentrations of the standard solutions. FIG. 2 shows as an example a diagram in which measured values of an ammonium concentration above the known ammonium concentration of the standard solutions used for determining the measured values are plotted as measuring points. A best-fit line was calculated as the best-fit function. This best-fit line can be displayed on the display 18 by the analysis apparatus electronics 2 in order to allow a user to check the measurement accuracy over the entire measurement range or over parts of the measurement range of the analysis apparatus 1. In addition, the measured values can be displayed in order to make it possible to assess the deviations of the measured values from the actual values over the entire measurement range.

The analysis apparatus electronics 2 can further be configured to determine and output or display a correlation coefficient of the best-fit function. This can also act as a measure for testing the functioning of the analysis apparatus 1. Based on a deviation of the correlation coefficient from a target value, the analysis apparatus electronics 2 can independently test whether the correlation is still sufficient to ensure sufficient functionality and measured value accuracy of the analysis apparatus 1. If this is no longer the case because the deviation is too high, the analysis apparatus electronics 2 can carry out a self-adjustment of the analysis apparatus 1 and/or output a warning message.

The analysis apparatus electronics 2 can be configured to perform a self-calibration or self-adjustment based on a calibration function or calibration table determined from the development of the measurement signals from the radiation detector 11 as a function of the known values of the parameter to be determined, e.g. the known analyte concentrations. The newly determined calibration function or calibration table is stored in the memory of the analysis apparatus electronics 2 and used for determining measured values for unknown liquid samples in the subsequent measurement cycles of the analysis apparatus 1 from measurement signals of the radiation detector 11.

The present disclosure described here on the basis of an exemplary embodiment can be used quite analogously for a multiplicity of similar analysis apparatuses without deviating from the inventive idea. For example, pumps other than syringe pumps, e.g. hose pumps or diaphragm pumps, and other valve devices can be used for metering and transporting solutions and for mixing the standard solutions. In further embodiments falling within the scope of the inventive idea, the analysis apparatus can have its own mixing and/or metering unit, e.g. comprising a metering vessel with fill level measuring devices for determining the dose. This can serve to measure the volumes of the stock solution and/or the dilution liquid to be used for the production of the standard liquids. It is also possible to use the method according to the present disclosure in analysis apparatuses which are configured to determine a sum parameter whose value is influenced not only by the concentration of a single analyte but by the concentration of a plurality of analytes. In this case, a stock solution can be used which contains one or more analytes or substances influencing the sum parameter in a known concentration, so that the value of the sum parameter determinable based on a standard solution produced from the stock solution and a dilution liquid is likewise known.

1. A method for testing, verifying, calibrating or adjusting an automatic analysis apparatus for determining a parameter dependent on the concentration of at least one substance in a sample liquid, comprising:
determining a first measured value representing a value of the parameter in a first standard solution by means of the automatic analysis apparatus, wherein the value of the parameter in the first standard solution is known; and
determining at least one second measured value representing a value of the parameter in at least one second standard solution by means of the automatic analysis apparatus, wherein the value of the parameter in the at least one second standard solution is known and differs from the value of the parameter in the first standard solution;
wherein the first standard solution or the at least one second standard solution are automatically produced by means of the analysis apparatus by mixing a predetermined volume of at least one stock solution containing the at least one substance and a predetermined volume of a dilution liquid.

2. The method of claim 1,
wherein the analysis apparatus has a mixing device and analysis apparatus electronics, and
wherein the analysis apparatus electronics control the mixing device to produce the first or the at least one second standard solution.

3. The method of claim 2,
wherein the mixing device has a valve device and at least one pump, wherein the valve device is configured to create a fluid connection between the at least one pump and a storage container containing the stock solution or a dilution liquid source.

4. The method of claim 3,
wherein, to produce the standard solutions, the analysis apparatus electronics control the at least one pump and the valve device in order to convey a predetermined volume of the stock solution and a predetermined volume of the dilution liquid and to mix the predetermined volumes of the stock solution and the dilution liquid with one another.

5. The method of claim 4, further comprising:
determining, from the first and the at least one second measured value and the values of the parameter in the first and the at least one second standard solution, by means of the analysis apparatus electronics, a predetermined model function, which reflects the development of the first and the at least one second measured value as a function of the values of the parameter.

6. The method of claim 5, further comprising:
displaying of the model function on a display of the analysis apparatus.

7. The method of claim 5, further comprising:
determining a correlation coefficient of the model function and comparing it with a target value of the correlation coefficient.

8. The method according to claim 5,
adjusting the analysis apparatus by storing a calibration function derived from the determined model function for determining measured values of the parameter.

9. An automatic analysis apparatus for determining a parameter of a sample liquid that is dependent on the concentration of at least one substance, comprising:
at least one storage container with a stock solution containing the at least one substance;
a mixing device configured to mix a predeterminable volume of the stock solution with a predeterminable volume of the dilution liquid so as to obtain a standard solution having a known value of the parameter in the standard solution;
analysis apparatus electronics; and
a measuring sensor which is connected to the analysis apparatus electronics to transmit measurement signals from the measuring sensor to the analysis apparatus electronics and which is designed to generate a measurement signal representing a value of the parameter in the standard solution;
wherein the analysis apparatus electronics are configured to control the mixing device and to process the measurement signal from the measuring sensor in order to determine a measured value representing the value of the parameter in the standard solution.

10. The automatic analysis apparatus of claim 9,
wherein the value of the parameter in the stock solution is greater than or equal to 80% of the upper limit of a measurement range of the analysis apparatus.
